(19) United States
(12) Patent Application Publication
(10) Pub. No.: US 2026/0101192 A1
(43) Pub. Date: Apr. 9, 2026

(54) SYSTEMS AND METHODS FOR IDENTIFYING AND CONFIGURING UNMANAGED FEMTOCELLS

(71) Applicant: Verizon Patent and Licensing Inc., Basking Ridge, NJ (US)

(72) Inventor: Pritesh PATEL, Monroe Twp, NJ (US)

(73) Assignee: Verizon Patent and Licensing Inc., Basking Ridge, NJ (US)

(21) Appl. No.: 18/906,623

(22) Filed: Oct. 4, 2024

(51) Int. Cl. H04W 12/122; H04W 76/10; H04W 76/30

(52) U.S. Cl. CPC H04W 12/122; H04W 76/10; H04W 76/30

(57) ABSTRACT

A device may maintain a data structure that includes first identifiers of femtocells associated with a femtocell core network, and may connect with a management network device associated with the femtocell core network. The device may receive, from the management network device, second identifiers of femtocells associated with a secure network device of the femtocell core network, and may compare the first identifiers and the second identifiers to determine whether the first identifiers match corresponding second identifiers. The device may identify, based on comparing the first identifiers and the second identifiers, an unmanaged femtocell associated with a second identifier that fails to match the first identifiers, and may perform a corrective action based on identifying the unmanaged femtocell.

### BACKGROUND

Femtocells (e.g., network extenders) may enhance coverage and capacity of networks, especially in residential and enterprise environments.

### BRIEF DESCRIPTION OF THE DRAWINGS

FIGS. 1A-1F are diagrams of an example associated with identifying and configuring unmanaged femtocells.

FIG. 2 is a diagram of an example environment in which systems and/or methods described herein may be implemented.

FIG. 3 is a diagram of example components of one or more devices of FIG. 2.

FIG. 4 is a flowchart of an example process for identifying and configuring unmanaged femtocells.

### DETAILED DESCRIPTION OF EXAMPLE EMBODIMENTS

The following detailed description of example implementations refers to the accompanying drawings. The same reference numbers in different drawings may identify the same or similar elements.

Femtocells are typically managed by a management system, such as a femtocell element management system (FeMS) or a home eNodeB management system (HeMS). The management system may oversee operation and connectivity of the femtocells within a larger network. The management system is responsible for configuring and maintaining network parameters that the femtocells use to connect and remain functional. However, some femtocells may become unmanaged by the management system due to network issues, which may lead to a disruption in communication with the management system. When a new femtocell is added to a network, the management system may erroneously assign the same network configuration being utilized by one of the unmanaged femtocells. This may cause operational issues for the new femtocell and may disrupt service for customers who wish to utilize the new femtocell. Thus, current techniques for managing femtocells consume computing resources (e.g., processing resources, memory resources, communication resources, and/or the like), networking resources, and/or other resources associated with assigning, to a new femtocell, a network configuration that is impermissibly being utilized by an unmanaged or rogue femtocell, handling operational issues of the new femtocell caused by the unmanaged or rogue femtocell, handling customer complaints associated with non-operational new femtocells, managing security risks associated with rogue femtocells, and/or the like.

Some implementations described herein provide a management system that identifies and configures unmanaged femtocells. For example, the management system may maintain a data structure that includes first identifiers of femtocells associated with a network, and may connect with a management network device associated with the network. The management system may receive, from the management network device, second identifiers of femtocells associated with a secure network device of the network, and may compare the first identifiers and the second identifiers to determine whether the first identifiers match corresponding second identifiers. The management system may identify, based on comparing the first identifiers and the second identifiers, an unmanaged femtocell associated with a second identifier that fails to match the first identifiers, and may perform a corrective action based on identifying the unmanaged femtocell.

In this way, the management system identifies and configures unmanaged femtocells. For example, the management system may enhance coordination with femtocells, and may reduce operational failures and service disruptions associated with femtocells. The management system may identify and resolve conflicts due to duplicated or outdated femtocell network parameters. The management system may protect network integrity through prompt detection and resolution of unmanaged femtocells and potential rogue femtocells. Thus, the management system may conserve computing resources, networking resources, and/or other resources that would have otherwise been consumed by assigning, to a new femtocell, a network configuration that is impermissibly being utilized by an unmanaged or rogue femtocell, handling operational issues of the new femtocell caused by the unmanaged or rogue femtocell, handling customer complaints associated with non-operational new femtocell, managing security risks associated with rogue femtocells, and/or the like.

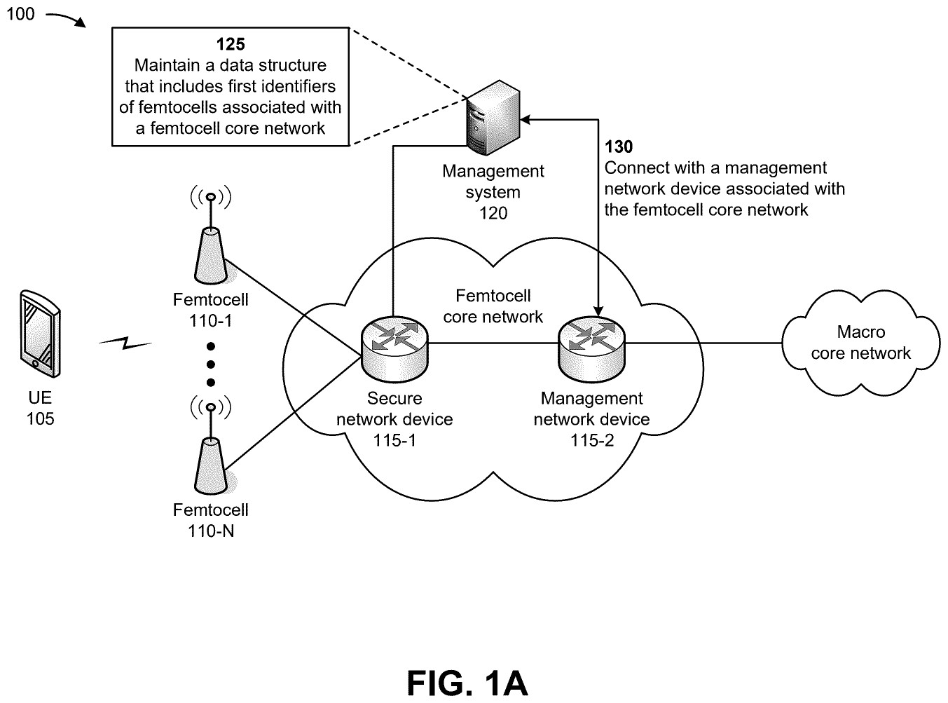

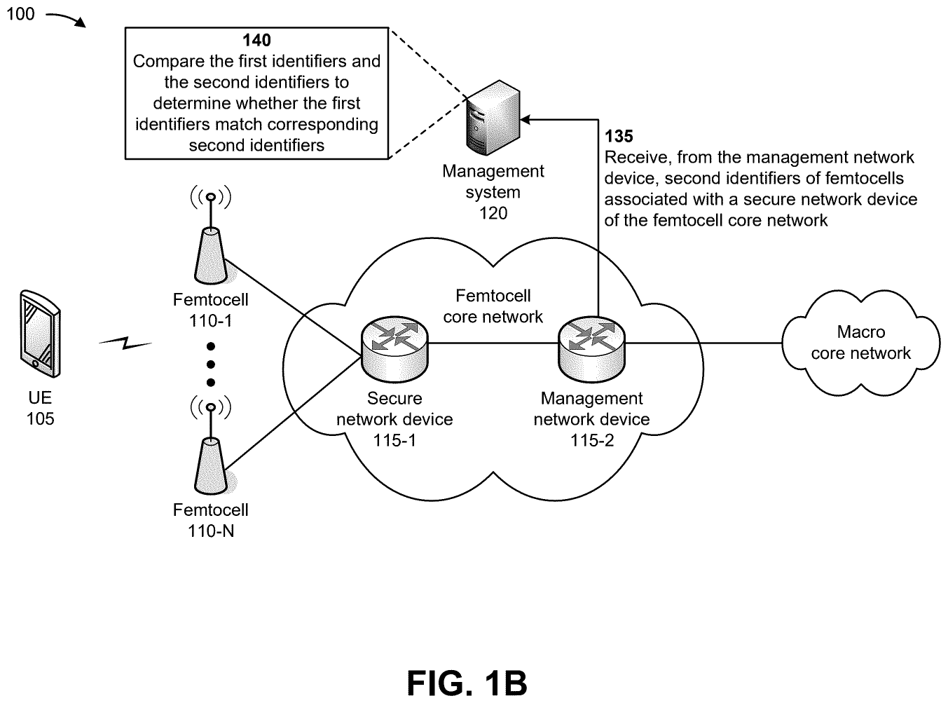

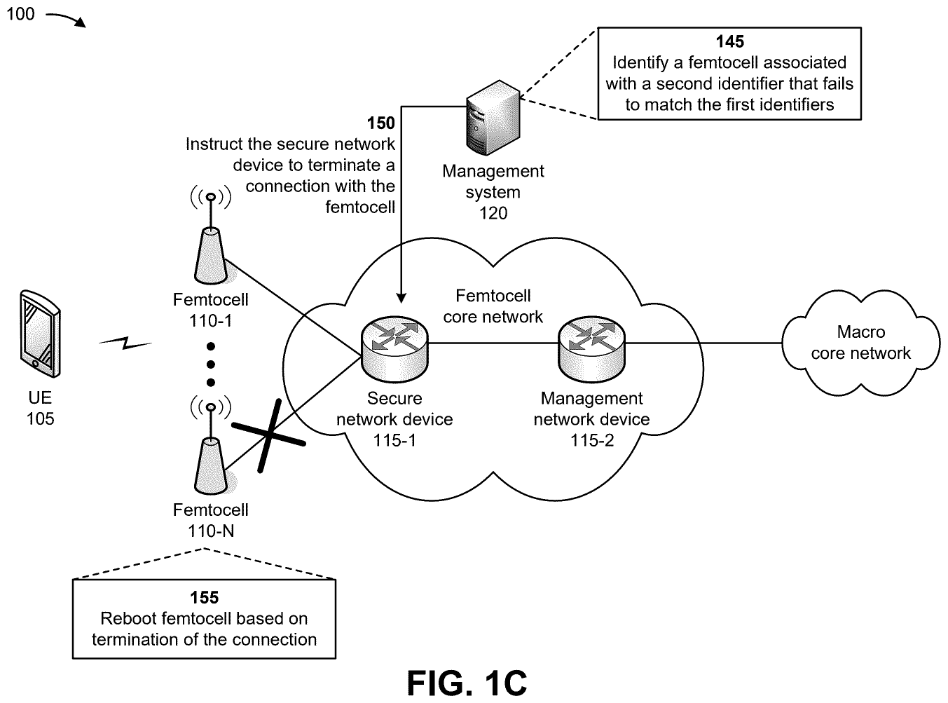

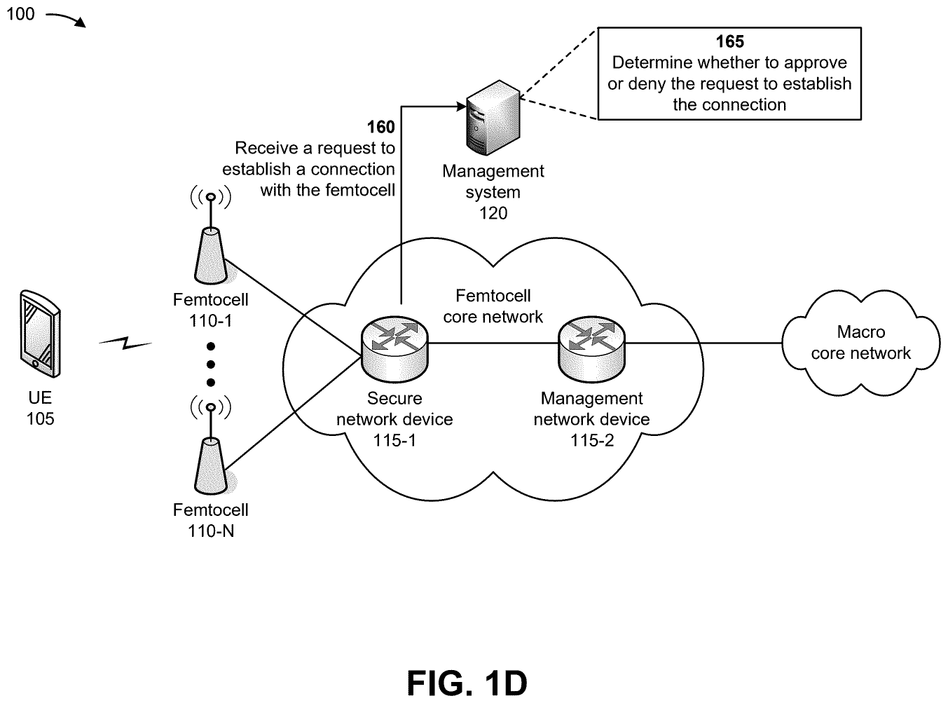

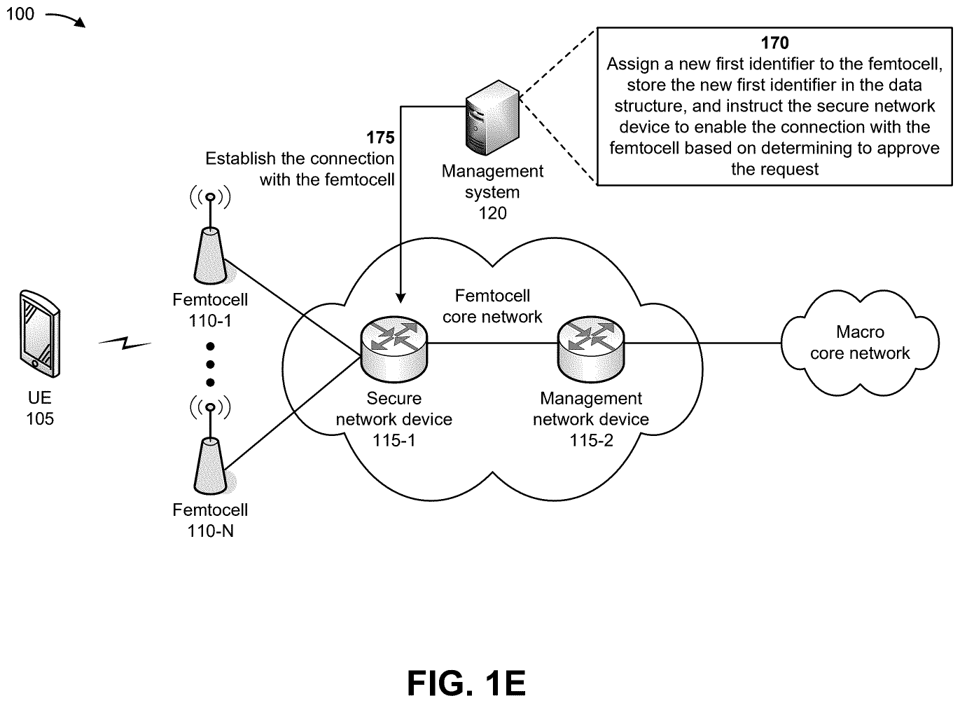

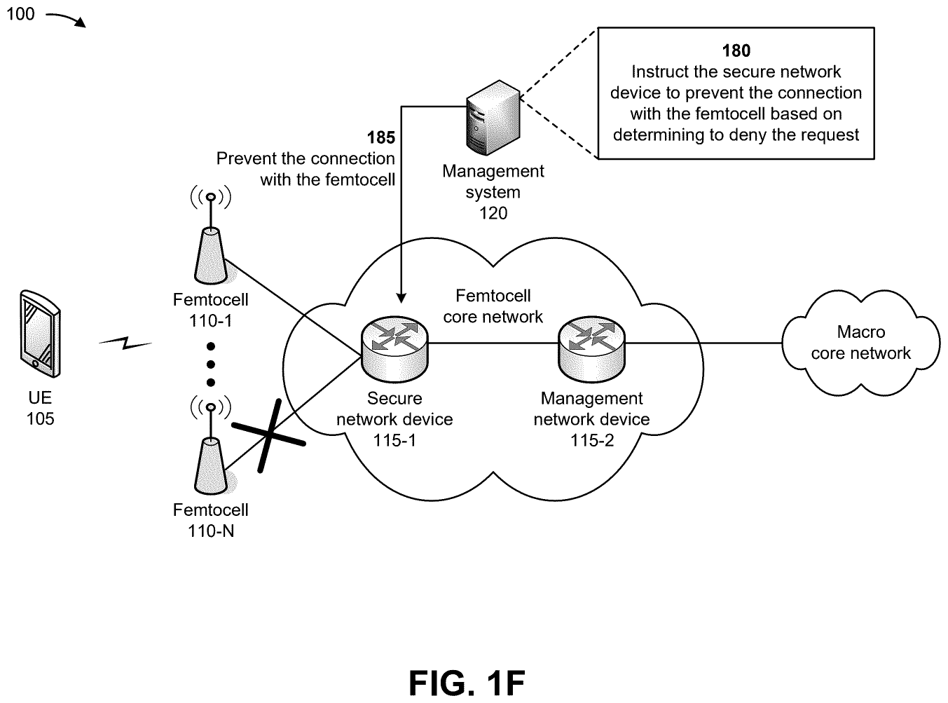

FIGS. 1A-1F are diagrams of an example 100 associated with identifying and configuring unmanaged femtocells. As shown in FIGS. 1A-1F, example 100 includes a user equipment (UE) 105 associated with a femtocell core network, a macro core network, and a management system 120. The femtocell core network may include multiple femtocells 110-1 through 110-N (also referred to herein as femtocell 110 or femtocells 110), a secure network device 115-1, and a management network device 115-2. The macro core network may include a core network for a fifth generation (5G) network, a fourth generation (4G) network, a long-term evolution (LTE) network, a third generation (3G) network, and/or the like. Further details of the UE 105, the femtocells 110-1 through 110-N, the secure network device 115-1, the management network device 115-2, the management system 120, the femtocell core network, and the macro core network are provided elsewhere herein.

As shown in FIG. 1A, and by reference number 125, the management system 120 may maintain a data structure (e.g., a database, a table, a list, and/or the like) that includes first identifiers of femtocells 110 associated with the femtocell core network. For example, the management system 120 may store unique identifiers (e.g., cell identifiers (IDs)) assigned to the femtocells 110 operating within the femtocell core network. In some implementations, the management system 120 may store device-specific information, such as firmware versions and hardware configurations for the femtocells 110, in the data structure. This may aid in managing updates and ensuring compatibility across the femtocell core network.

Additionally, or alternatively, the management system 120 may also store, in the data structure, network performance metrics (e.g., signal strength and data throughput) associated with the femtocells 110. The performance metrics can aid in optimizing network performance and identifying any areas requiring attention. Additionally, or alternatively, the data structure may also include security credentials or encryption keys necessary for the femtocells 110 to operate securely within the femtocell core network. Additionally, or alternatively, the management system 120 may store, in the data structure, billing-related data that includes subscription details for different femtocells 110. Additionally, or alternatively, the data structure may include error logs or diagnostic information for identifying recurring issues with specific femtocells 110. This may facilitate proactive maintenance and troubleshooting.

As further shown in FIG. 1A, and by reference number 130, the management system 120 may connect with the management network device 115-2 associated with the femtocell core network. For example, the management system 120 may establish a secure transmission control protocol (TCP) connection with the management network device 115-2 to facilitate the exchange of information between the devices. This connection may enable real-time communication and synchronization of network parameters, ensuring accurate tracking and management of femtocell configurations. In some implementations, the management system 120 may establish a secure hypertext transfer protocol secure (HTTPS) session with the management network device 115-2 for information exchange. Additionally, or alternatively, instead of TCP, the management system 120 may utilize a secure socket layer (SSL) or a transport layer security (TLS) protocol to connect with the management network device 115-2 and ensure encrypted communication. Additionally, or alternatively, the management system 120 may connect with the management network device 115-2 over a virtual private network (VPN) to provide an additional layer of security and to ensure that data transmission is protected from external threats.

Additionally, or alternatively, the management system 120 may utilize a custom-built secure application programming interface (API) to interface with the management network device 115-2, facilitating real-time updates and configuration changes. Additionally, or alternatively, wireless communication protocols may be utilized to connect the management system 120 and the management network device 115-2. Additionally, or alternatively, the management system 120 may implement a periodic heartbeat signal with the management network device 115-2 to continuously monitor the health and status of the connection. This may ensure immediate detection of connection issues. Additionally, or alternatively, the connection may enable remote diagnostic and troubleshooting capabilities between the management system 120 and the management network device 115-2, allowing network administrators to resolve issues without physical intervention.

As shown in FIG. 1B, and by reference number 135, the management system 120 may receive, from the management network device 115-2, second identifiers of femtocells 110 associated with the secure network device 115-1 of the femtocell core network. For example, the management network device 115-2 may transmit the second identifiers, which uniquely identify the femtocells 110 operating within the secure network device 115-1, to the management system 120, and the management system 120 may receive the second the second identifiers. In some implementations, the management system 120 may periodically receive the second identifiers, may continuously receive the second identifiers, may receive the second identifiers in response to specific events, such as a femtocell reboot or network configuration change, and/or the like.

In some implementations, the management system 120 may periodically query the management network device 115-2 to retrieve the second identifiers of femtocells 110 associated with the secure network device 115-1. For example, the management system 120 may schedule routine queries every few minutes to maintain up-to-date second identifier logs. Additionally, or alternatively, the management network device 115-2 may push the second identifiers to the management system 120 in real-time as changes are detected. Additionally, or alternatively, the management system 120 may subscribe to notifications from the management network device 115-2. The notifications may include the second identifiers of femtocells 110 associated with the secure network device 115-1. Additionally, or alternatively, the management system 120 may receive the second identifiers of femtocells 110 associated with the secure network device 115-1 as part of a health-check or heartbeat mechanism initiated by the management network device 115-2. Additionally, or alternatively, the management network device 115-2 may proactively provide the second identifiers to the management system 120 anytime a femtocell 110 undergoes a status change, such as a firmware update or a relocation. For example, whenever femtocells 110 complete a firmware update, the updated identifiers may be automatically communicated to the management system 120.

As further shown in FIG. 1B, and by reference number 140, the management system 120 may compare the first identifiers and the second identifiers to determine whether the first identifiers match corresponding second identifiers. For example, the management system 120 may cross-reference the first and second identifiers to detect any discrepancies. In some implementations, comparing the first and second identifiers may include utilizing a checksum or a hash comparison to quickly determine matches or mismatches between first and second identifiers. For example, a hash function can be applied to the first and second identifiers to expedite the comparison process. Additionally, or alternatively, the management system 120 may precompute a table of known good matches during off-peak hours to expedite the comparison process. Additionally, or alternatively, the management system 120 may utilize a distributed ledger or blockchain to verify the authenticity and consistency of the first identifiers and the second identifiers. Additionally, or alternatively, the management system 120 may utilize a secure, encrypted channel to ensure that data integrity is maintained during the comparison process.

In some implementations, if a second identifier does not match a corresponding first identifier stored in the data structure of the management system 120, the management system 120 may determine that a femtocell 110 associated with the second identifier is unmanaged or rogue. This comparison may ensure that all femtocells 110 associated with the femtocell core network are accounted for and managed properly, thereby preventing potential conflicts or security issues.

As shown in FIG. 1C, and by reference number 145, the management system 120 may identify a femtocell 110-N associated with a second identifier that fails to match the first identifiers. For example, the management system 120 may compare the first identifiers and the second identifiers to determine any discrepancies. In some implementations, the discrepancies may indicate unmanaged or rogue femtocells 110 within the femtocell core network. In some implementations, based on comparing the first identifiers and the second identifiers, the management system 120 may determine a second identifier that does not correspond to any of the first identifiers. The management system 120 may identify the femtocell (e.g., the femtocell 110-N) that corresponds to the determined second identifier.

In some implementations, the management system 120 may continuously update the data structure to maintain an accurate registry of authorized femtocells 110. Additionally, or alternatively, the management system 120 may identify the femtocell 110-N by cross-referencing the received second identifiers against first identifiers of registered femtocells 110 stored in the data structure. Additionally, or alternatively, the management system 120 may flag femtocells 110 associated with discrepancies in unique identifiers for further investigation and verification. This may ensure that any potential misconfigurations can be promptly addressed.

As further shown in FIG. 1C, and by reference number 150, the management system 120 may instruct the secure network device 115-1 to terminate a connection with the femtocell 110-N. For example, upon identifying the mismatched femtocell 110-N, the management system 120 may provide a termination command to the secure network device 115-1. The termination command may instruct the secure network device 115-1 to terminate the connection with the mismatched femtocell 110-N. Upon receipt of the termination command, the secure network device 115-1 may terminate an existing connection with the mismatched femtocell 110-N. In some implementations, the management system 120 may instruct the secure network device 115-1 to isolate the femtocell 110-N by blocking data traffic of the femtocell 110-N until further measures are taken. This may enable temporary containment of the femtocell 110-N while the issue is being resolved. Additionally, or alternatively, the management system 120 may temporarily disable the femtocell 110-N and may notify a network administrator for manual inspection. This may ensure human oversight and potential intervention for more complex issues.

As further shown in FIG. 1C, and by reference number 155, the femtocell 110-N may reboot based on the termination of the connection. For example, the femtocell 110-N, upon receiving the termination command, may automatically begin a reboot sequence as a part of a built-in back-off mechanism to reestablish a connection with updated parameters. In some implementations, the femtocell 110-N may automatically initiate a reboot sequence to reset parameters following receipt of the termination command from the secure network device 115-1. This may ensure that the femtocell 110-N attempts to reconnect with valid parameters. Additionally, or alternatively, the femtocell 110-N may enter a recovery mode to obtain a new network configuration upon termination of the connection. The recovery mode may enable the femtocell 110-N to self-correct and reconfigure based on updated network settings. Additionally, or alternatively, the femtocell 110-N may attempt reconnection after a predefined delay. The predefined delay may provide a buffer period for any configuration changes to take effect in the femtocell 110-N.

As shown in FIG. 1D, and by reference number 160, the management system 120 may receive a request to establish a connection with the femtocell 110-N. For example, after the management system 120 terminates the initial connection with the femtocell 110-N and the femtocell 110-N reboots, the femtocell 110-N may attempt to reestablish the connection with the secure network device 115-1. The femtocell 110-N may provide the request to establish the connection to the secure network device 115-1, and the secure network device 115-1 may provide the request to establish the connection to the management system 120. The management system 120 may receive the request to establish the connection from the secure network device 115-1. The request may include updated network parameters, such as a new cell identifier (ID) and an Internet protocol (IP) address, provided by the femtocell 110-N at reboot. In some implementations, the management system 120 may receive the request from the secure network device 115-1 whenever the femtocell 110-N attempts to reestablish a network connection. In some implementations, the management system 120 may receive the request to establish the connection via a secure transmission control protocol (TCP)-based connection with the secure network device 115-1. This may ensure that the communication channel is protected against unauthorized access or tampering. Additionally, or alternatively, the request to establish the connection may include security credentials or authentication tokens along with the updated network parameters. This may ensure that only authenticated and authorized femtocells 110 are allowed to connect to the femtocell core network.

As further shown in FIG. 1D, and by reference number 165, the management system 120 may determine whether to approve or deny the request to establish the connection with the femtocell 110-N. For example, the management system 120 may cross-reference the provided network parameters in the request to establish the connection with the data structure to ensure that the network parameters do not conflict with network parameters of other femtocells 110 already being managed in the femtocell core network by the management system 120. If the provided network parameters are valid and unique, the management system 120 may approve the request to establish the connection. Conversely, if the provided network parameters conflict with network parameters of other femtocells 110, or other criteria for connection approval are not satisfied, the management system 120 may deny the request to establish the connection. The management system 120 may utilize various verification and validation mechanisms, such as checksum comparison or machine learning models, to accurately determine the validity of the request to establish the connection. In some implementations, the management system 120 may utilize network performance metrics and security considerations when determining whether to approve or deny the request in order to optimize network integrity and performance. In some implementations, the management system 120 may perform network health checks before deciding to approve or deny the request to establish the connection. For example, the management system 120 ensuring that the femtocell core network is not overloaded or experiencing issues before allowing a new connection may help maintain overall network performance.

Additionally, or alternatively, the management system 120 may utilize a rule-based engine to evaluate the request to establish the connection, instead of or in addition to machine learning models. Additionally, or alternatively, the management system 120 may utilize a third-party security service to assist in validating the request to establish the connection. For example, the management system 120 may utilize an external service to ensure compliance with security standards and prevent potential threats. Additionally, or alternatively, the management system 120 may log the request details for auditing purposes before making a decision. Additionally, or alternatively, the management system 120 may apply threshold criteria, such as network load balancing considerations, when determining whether to approve or deny the connection request. This may ensure that the femtocell core network remains stable and optimally balanced during load variations.

As shown in FIG. 1E, and by reference number 170, the management system 120 may assign a new first identifier to the femtocell 110-N, may store the new first identifier in the data structure, and may instruct the secure network device 115-1 to enable the connection with the femtocell 110-N based on determining to approve the request. For example, based on determining to approve the request, the management system 120 may assign, to the femtocell 110-N, a new first identifier (e.g., a unique cell ID) that is not currently in use within the femtocell core network. This may prevent any conflicts with existing femtocells 110 managed by the management system 120. In some implementations, once the new first identifier is assigned, the management system 120 may update the data structure to include the new first identifier and may provide the new first identifier to the secure network device 115-1. Furthermore, based on determining to approve the request, the management system 120 may instruct the secure network device 115-1 to enable the connection with the femtocell 110-N.

Additionally, or alternatively, after assigning the new first identifier, the management system 120 may record the new first identifier in a centralized database accessible to all network components of the femtocell core network. Additionally, or alternatively, the management system 120 may validate the new first identifier to ensure uniqueness before storing the new first identifier in the data structure. The validation may include cross-referencing the new first identifier against existing identifiers in order to avoid duplication. Additionally, or alternatively, instead of assigning a new first identifier, the management system 120 may assign a pre-approved identifier to the femtocell 110-N. The pre-approved identifier may be part of a pool of reserved identifiers that are readily available for such reassignment scenarios. Additionally, or alternatively, the management system 120 may send a notification to an administrator about the new first identifier. The notification may include details about a reason for reassigning a first identifier for the femtocell 110-N and the specifics of the new first identifier.

As further shown in FIG. 1E, and by reference number 175, the management system 120 may establish the connection with the femtocell 110-1. For example, after updating the data structure with the new first identifier and instructing the secure network device 115-1 to enable the connection, the management system 120 may facilitate the re-establishment of a secure connection between the femtocell 110-N and the secure network device 115-1. This may ensure that the femtocell 110-N can operate within the femtocell core network with proper and unique network parameters, thus mitigating potential disruptions or conflicts with other femtocells 110. Additionally, or alternatively, the management system 120 may utilize encryption to securely communicate the new first identifier to the femtocell 110-N. This encrypted communication may ensure that the new first identifier is not exposed to unauthorized entities. Additionally, or alternatively, the secure network device 115-1 may confirm establishment of the connection to the management system 120. The confirmation may enable the management system 120 to verify that the connection has been successfully re-established with the femtocell 110-N.

As shown in FIG. 1F, and by reference number 180, the management system 120 may instruct the secure network device 115-1 to prevent the connection with the femtocell 110-N based on determining to deny the request. For example, the management system 120 may evaluate the request to establish the connection from the femtocell 110-N, and upon finding issues such as security risks or parameter conflicts, may choose to deny the request. Based on determining to deny the request, the management system 120 may instruct the secure network device 115-1 to prevent any connection attempts from the identified femtocell 110-N.

In some implementations, the management system 120 may instruct the secure network device 115-1 to terminate any existing connection with the femtocell 110-N. For example, if the femtocell 110-N has already established a connection, the management system 120 may determine that the connection is unauthorized and may instruct the secure network device 115-1 to end the connection immediately. Additionally, or alternatively, the management system 120 may instruct the secure network device 115-1 to trigger a reboot of the femtocell 110-N upon denying the connection request, in order to force reinitialization of connection parameters. This may ensure that any temporary parameters causing connection issues are reset. Additionally, or alternatively, the management system 120 may communicate with the secure network device 115-1 to apply updated security policies that restrict the femtocell 110-N from accessing certain network resources. For example, the secure network device 115-1 may block the femtocell 110-N from segments of the network, maintaining the overall integrity of the femtocell core network.

As further shown in FIG. 1F, and by reference number 185, the management system 120 may prevent the connection with the femtocell 110-N. For example, upon receiving the instruction from the management system 120, the secure network device 115-1 may execute measures to block the femtocell 110-N from forming any connections within the femtocell core network. This may include applying network access controls or blacklisting an identifier of the femtocell 110-N, thereby ensuring network integrity and preventing unauthorized access or disturbances.

In some implementations, the management system 120 may provide a notification to a network administrator regarding the denied connection attempt by the femtocell 110-N, along with details for further review and action. For example, the management system 120 may provide the network administrator with specific information, such as timestamps, access points, and reasons for denial. Additionally, or alternatively, the management system 120 may implement a real-time monitoring procedure to detect any further unauthorized connection attempts by the femtocell 110-N. Continuous surveillance measures may be utilized to immediately recognize and respond to future connection attempts by the femtocell 110-N.

In this way, the management system 120 identifies and configures unmanaged femtocells 110. For example, the management system 120 may enhance coordination with femtocells 110, and may reduce operational failures and service disruptions associated with femtocells 110. The management system 120 may identify and resolve conflicts due to duplicated or outdated femtocell network parameters. The management system 120 may protect network integrity through prompt detection and resolution of unmanaged femtocells 110 and potential rogue femtocells 110. Thus, the management system 120 may conserve computing resources, networking resources, and/or other resources that would have otherwise been consumed by assigning, to a new femtocell 110, a network configuration that is impermissibly being utilized by an unmanaged or rogue femtocell 110, handling operational issues of the new femtocell 110 caused by the unmanaged or rogue femtocell 110, handling customer complaints associated with non-operational new femtocells 110, managing security risks associated with rogue femtocells 110, and/or the like.

As indicated above, FIGS. 1A-1F are provided as an example. Other examples may differ from what is described with regard to FIGS. 1A-1F. The number and arrangement of devices shown in FIGS. 1A-1F are provided as an example. In practice, there may be additional devices, fewer devices, different devices, or differently arranged devices than those shown in FIGS. 1A-1F. Furthermore, two or more devices shown in FIGS. 1A-1F may be implemented within a single device, or a single device shown in FIGS. 1A-1F may be implemented as multiple, distributed devices. Additionally, or alternatively, a set of devices (e.g., one or more devices) shown in FIGS. 1A-1F may perform one or more functions described as being performed by another set of devices shown in FIGS. 1A-1F.

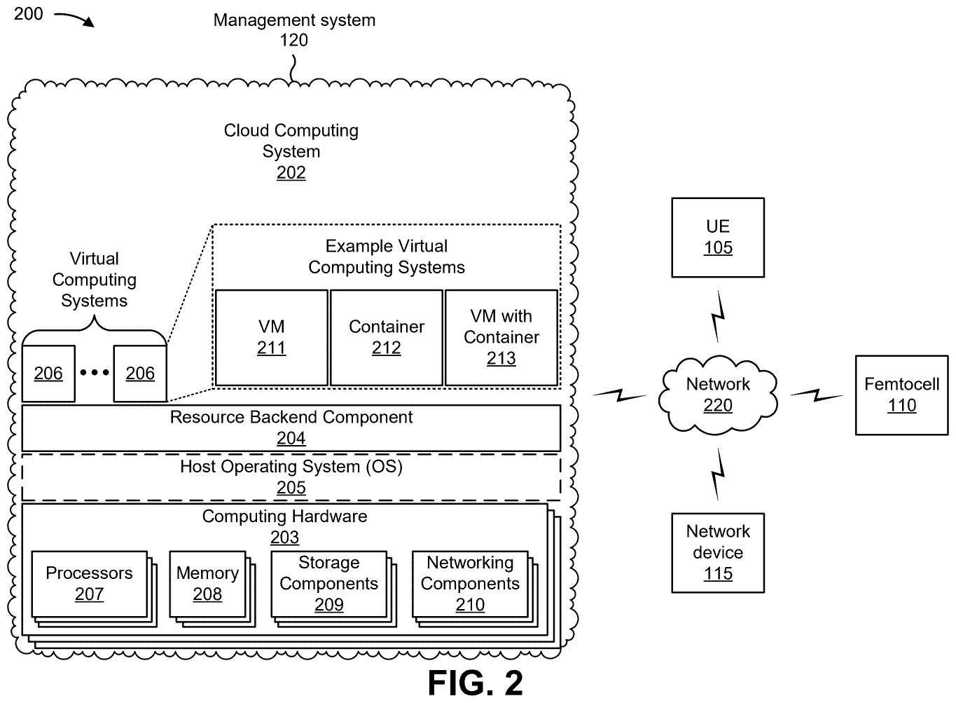

FIG. 2 is a diagram of an example environment 200 in which systems and/or methods described herein may be implemented. As shown in FIG. 2, the environment 200 may include the management system 120, which may include one or more elements of and/or may execute within a cloud computing system 202. The cloud computing system 202 may include one or more elements 203-213, as described in more detail below. As further shown in FIG. 2, the environment 200 may include the UE 105, the femtocell 110, the network device 115, and/or a network 220. Devices and/or elements of the environment 200 may interconnect via wired connections and/or wireless connections.

The UE 105 includes one or more devices capable of receiving, generating, storing, processing, and/or providing information, such as information described herein. For example, the UE 105 may include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The femtocell 110 includes one or more devices capable of receiving, generating, storing, processing, and/or providing information, as described elsewhere herein. For example, the femtocell 110 may include a femtocell base station, a network extender, a home gNodeB, a portable plug and play mini base station, and/or the like. In some implementations, the femtocell 110 may include a small, low-power cellular base station designed to enhance network coverage and improve signal quality in areas with weak cellular signals (e.g., such as at home locations, small business locations, and/or the like).

The network device 115 includes one or more devices capable of receiving, processing, storing, routing, and/or providing traffic (e.g., a packet or other information or metadata) in a manner described herein. For example, the network device 115 may include a router, such as a label switching router (LSR), a label edge router (LER), an ingress router, an egress router, a provider router (e.g., a provider edge router or a provider core router), a virtual router, a route reflector, an area border router, or another type of router. Additionally, or alternatively, the network device 115 may include a gateway, a switch, a firewall, a hub, a bridge, a reverse proxy, a server (e.g., a proxy server, a cloud server, or a data center server), a load balancer, and/or a similar device. In some implementations, the network device 115 may be a physical device implemented within a housing, such as a chassis. In some implementations, the network device 115 may be a virtual device implemented by one or more computer devices of a cloud computing environment or a data center. In some implementations, a group of network devices 115 may be a group of data center nodes that are used to route traffic flow through a network.

The cloud computing system 202 includes computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 includes hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, one or more storage components 209, and/or one or more networking components 210. Examples of a processor, a memory, a storage component, and a networking component (e.g., a communication component) are described elsewhere herein.

The resource management component 204 includes a virtualization application (e.g., executing on hardware, such as the computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 211. Additionally, or alternatively, the resource management component 204 may include a container manager, such as when the virtual computing systems 206 are containers 212. In some implementations, the resource management component 204 executes within and/or in coordination with a host operating system 205.

A virtual computing system 206 includes a virtual environment that enables cloud-based execution of operations and/or processes described herein using the computing hardware 203. As shown, the virtual computing system 206 may include a virtual machine 211, a container 212, or a hybrid environment 213 that includes a virtual machine and a container, among other examples. The virtual computing system 206 may execute one or more applications using a file system that includes binary files, software libraries, and/or other resources required to execute applications on a guest operating system (e.g., within the virtual computing system 206) or the host operating system 205.

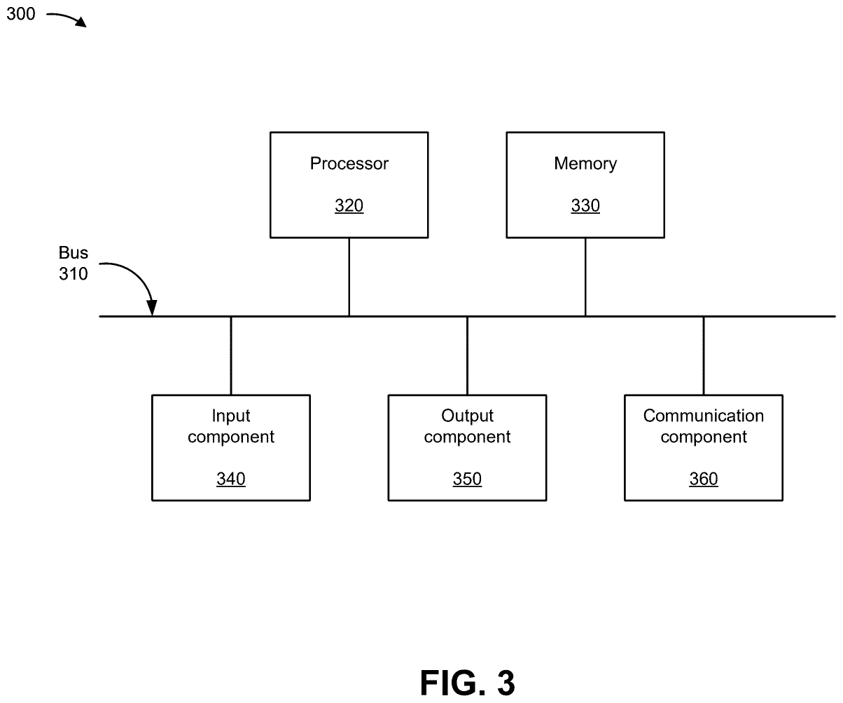

Although the management system 120 may include one or more elements 203-213 of the cloud computing system 202, may execute within the cloud computing system 202, and/or may be hosted within the cloud computing system 202, in some implementations, the management system 120 may not be cloud-based (e.g., may be implemented outside of a cloud computing system) or may be partially cloud-based. For example, the management system 120 may include one or more devices that are not part of the cloud computing system 202, such as the device 300 of FIG. 3, which may include a standalone server or another type of computing device. The management system 120 may perform one or more operations and/or processes described in more detail elsewhere herein.

The network 220 includes one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300, which may correspond to the UE 105, the femtocell 110, the network device 115, and/or the management system 120. In some implementations, the UE 105, the femtocell 110, the network device 115, and/or the management system 120 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection).

The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

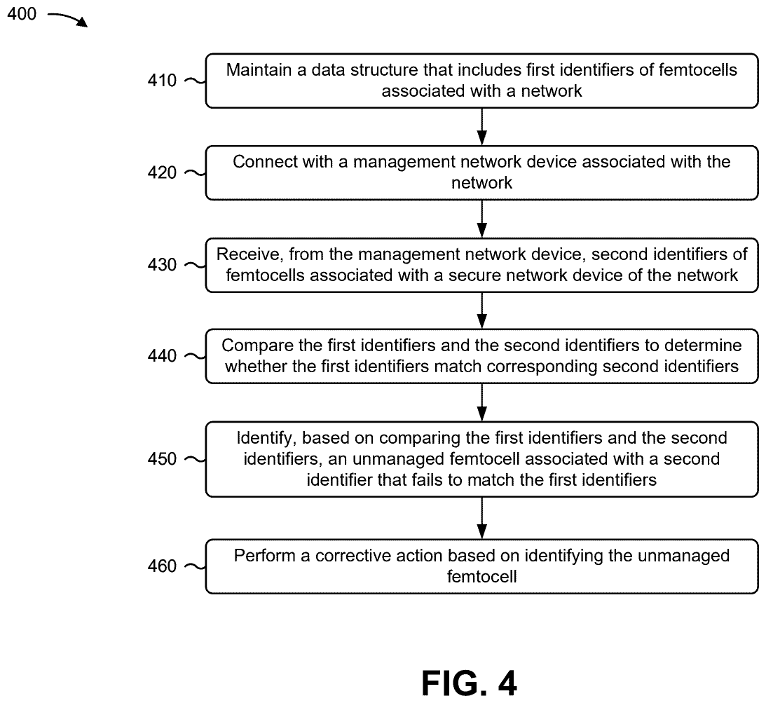

FIG. 4 is a flowchart of an example process 400 for identifying and configuring unmanaged femtocells. In some implementations, one or more process blocks of FIG. 4 may be performed by a device (e.g., the management system 120). In some implementations, one or more process blocks of FIG. 4 may be performed by another device or a group of devices separate from or including the device, such as a secure network device (e.g., the secure network device 115-1), a management network device (e.g., the management network device 115-2), and/or the like. Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include maintaining a data structure that includes first identifiers of femtocells associated with a network (block 410). For example, the device may maintain a data structure that includes first identifiers of femtocells associated with a femtocell core network, as described above.

As further shown in FIG. 4, process 400 may include connecting with a management network device associated with the network (block 420). For example, the device may connect with a management network device associated with the femtocell core network, as described above. In some implementations, connecting with the management network device includes connecting with the management network device via a secure TCP-based network connection.

As further shown in FIG. 4, process 400 may include receiving, from the management network device, second identifiers of femtocells associated with a secure network device of the network (block 430). For example, the device may receive, from the management network device, second identifiers of femtocells associated with a secure network device of the femtocell core network, as described above. In some implementations, the management network device is a femtocell gateway and the secure network device is a security gateway.

As further shown in FIG. 4, process 400 may include comparing the first identifiers and the second identifiers to determine whether the first identifiers match corresponding second identifiers (block 440). For example, the device may compare the first identifiers and the second identifiers to determine whether the first identifiers match corresponding second identifiers, as described above.

As further shown in FIG. 4, process 400 may include identifying, based on comparing the first identifiers and the second identifiers, an unmanaged femtocell associated with a second identifier that fails to match the first identifiers (block 450). For example, the device may identify, based on comparing the first identifiers and the second identifiers, an unmanaged femtocell associated with a second identifier that fails to match the first identifiers, as described above.

As further shown in FIG. 4, process 400 may include performing a corrective action based on identifying the unmanaged femtocell (block 460). For example, the device may perform a corrective action based on identifying the unmanaged femtocell, as described above.

In some implementations, performing the corrective action includes instructing the secure network device to terminate a connection with the unmanaged femtocell. In some implementations, performing the corrective action includes causing the unmanaged femtocell to reboot. In some implementations, performing the corrective action includes preventing the unmanaged femtocell from establishing a secure tunnel to the femtocell core network until the unmanaged femtocell reboots.

In some implementations, process 400 includes receiving, after termination of the connection with the unmanaged femtocell, a request to establish another connection with the unmanaged femtocell, and determining whether to approve or deny the request to establish the other connection with the unmanaged femtocell. In some implementations, process 400 includes assigning a new first identifier to the unmanaged femtocell based on determining to approve the request, storing the new first identifier in the data structure, and instructing the secure network device to enable the other connection with the unmanaged femtocell. In some implementations, process 400 includes instructing the secure network device to prevent the connection with the unmanaged femtocell based on determining to deny the request.

In some implementations, process 400 includes determining that the unmanaged femtocell is a rogue femtocell that is using unauthorized network resources. In some implementations, process 400 includes instructing the secure network device to terminate a connection with the rogue femtocell. In some implementations, process 400 includes providing a notification or an alert to a network administrator regarding the unmanaged femtocell. In some implementations, process 400 includes identifying, based on comparing the first identifiers and the second identifiers, a managed femtocell associated with a second identifier that matches one of the first identifiers, and permitting a continued connection with the managed femtocell.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more. ” Further, as used herein, the article “the” is intended to include one or more items referenced in connection with the article “the” and may be used interchangeably with “the one or more. ” Furthermore, as used herein, the term “set” is intended to include one or more items (e.g., related items, unrelated items, or a combination of related and unrelated items), and may be used interchangeably with “one or more. ” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either”or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
maintaining, by a device, a data structure that includes first identifiers of femtocells associated with a network;
connecting, by the device, with a management network device associated with the network;
receiving, by the device and from the management network device, second identifiers of femtocells associated with a secure network device of the network;
comparing, by the device, the first identifiers and the second identifiers to determine whether the first identifiers match corresponding second identifiers;
identifying, by the device and based on comparing the first identifiers and the second identifiers, an unmanaged femtocell associated with a second identifier that fails to match the first identifiers; and
performing, by the device, a corrective action based on identifying the unmanaged femtocell.

2. The method of claim 1, wherein performing the corrective action comprises:
instructing the secure network device to terminate a connection with the unmanaged femtocell.

3. The method of claim 1, wherein performing the corrective action comprises:
causing the unmanaged femtocell to reboot.

4. The method of claim 1, wherein performing the corrective action comprises:
preventing the unmanaged femtocell from establishing a secure tunnel to the femtocell core network until the unmanaged femtocell reboots.

5. The method of claim 1, further comprising:
receiving, after termination of the connection with the unmanaged femtocell, a request to establish another connection with the unmanaged femtocell; and
determining whether to approve or deny the request to establish the other connection with the unmanaged femtocell.

6. The method of claim 5, further comprising:
assigning a new first identifier to the unmanaged femtocell based on determining to approve the request;
storing the new first identifier in the data structure; and
instructing the secure network device to enable the other connection with the unmanaged femtocell.

7. The method of claim 5, further comprising:
instructing the secure network device to prevent the connection with the unmanaged femtocell based on determining to deny the request.

8. A device, comprising:
one or more processors configured to:
maintain a data structure that includes first identifiers of femtocells associated with a femtocell core network;
connect with a management network device associated with the femtocell core network;
receive, from the management network device, second identifiers of femtocells associated with a secure network device of the femtocell core network;
compare the first identifiers and the second identifiers to determine whether the first identifiers match corresponding second identifiers;
identify, based on comparing the first identifiers and the second identifiers, an unmanaged femtocell associated with a second identifier that fails to match the first identifiers; and
instruct the secure network device to terminate a connection with the unmanaged femtocell.

9. The device of claim 8, wherein the one or more processors, to connect with the management network device, are configured to:
connect with the management network device via a secure transmission control protocol-based network connection.

10. The device of claim 8, wherein the one or more processors are further configured to:
determine that the unmanaged femtocell is a rogue femtocell that is using unauthorized network resources.

11. The device of claim 10, wherein the one or more processors are further configured to:
instruct the secure network device to terminate a connection with the rogue femtocell.

12. The device of claim 8, wherein the one or more processors are further configured to:
provide a notification or an alert to a network administrator regarding the unmanaged femtocell.

13. The device of claim 8, wherein the management network device is a femtocell gateway and the secure network device is a security gateway.

14. The device of claim 8, wherein the one or more processors are further configured to:
identify, based on comparing the first identifiers and the second identifiers, a managed femtocell associated with a second identifier that matches one of the first identifiers; and
permit a continued connection with the managed femtocell.

15. A non-transitory computer-readable medium storing a set of instructions, the set of instructions comprising:
one or more instructions that, when executed by one or more processors of a device, cause the device to:
maintain a data structure that includes first identifiers of femtocells associated with a femtocell core network;
connect with a management network device associated with the femtocell core network;
receive, from the management network device, second identifiers of femtocells associated with a secure network device of the femtocell core network,
wherein the management network device is a femtocell gateway and the secure network device is a security gateway;
compare the first identifiers and the second identifiers to determine whether the first identifiers match corresponding second identifiers;
identify, based on comparing the first identifiers and the second identifiers, an unmanaged femtocell associated with a second identifier that fails to match the first identifiers; and
perform a corrective action based on identifying the unmanaged femtocell.

16. The non-transitory computer-readable medium of claim 15, wherein the one or more instructions, that cause the device to perform the corrective action, cause the device to one or more of:
instruct the secure network device to terminate a connection with the unmanaged femtocell;
cause the unmanaged femtocell to reboot; or
prevent the unmanaged femtocell from establishing a secure tunnel to the femtocell core network until the unmanaged femtocell reboots.

17. The non-transitory computer-readable medium of claim 15, wherein the one or more instructions further cause the device to:
receive, after termination of the connection with the unmanaged femtocell, a request to establish another connection with the unmanaged femtocell; and
determine whether to approve or deny the request to establish the other connection with the unmanaged femtocell.

18. The non-transitory computer-readable medium of claim 17, wherein the one or more instructions further cause the device to:
assign a new first identifier to the unmanaged femtocell based on determining to approve the request;
store the new first identifier in the data structure; and
instruct the secure network device to enable the other connection with the unmanaged femtocell.

19. The non-transitory computer-readable medium of claim 17, wherein the one or more instructions further cause the device to:
instruct the secure network device to prevent the connection with the unmanaged femtocell based on determining to deny the request.

20. The non-transitory computer-readable medium of claim 15, wherein the one or more instructions, that cause the device to connect with the management network device, cause the device to:
connect with the management network device via a secure transmission control protocol-based network connection.
